(19) United States
(12) Patent Application Publication
(10) Pub. No.: US 2026/0216675 A1
(43) Pub. Date: Jul. 30, 2026

(54) TAPERED VERTICAL BLENDER AND MEDIA COATING SYSTEM USING SAME

(71) Applicant: Ag Growth International Inc, Winnipeg (CA)

(72) Inventors: David GUTIERREZ, Plainfield, IL (US); Eric Jason Gard, Casey, IL (US); Jared Martin Smith, Lisle, IL (US); Robert Fitzpatrick, New Lennox, IL (US); Fred L. Dorman, Plainfield, IL (US); Ralph Moussa El Rassi, Bologna (IT)

(21) Appl. No.: 19/041,697

(22) Filed: Jan. 30, 2025

(51) Int. Cl. B01F 33/80; B01F 27/921; B01F 35/71; B01F 101/32

(52) U.S. Cl. CPC B01F 33/8363; B01F 27/921; B01F 33/8364; B01F 35/7179; B01F 2101/32

(57) ABSTRACT

The present invention relates to a media coating system designed to enhance the efficiency and quality of media coating processes. The system comprises a tapered vertical blender equipped with a forced-air system that communicates air through the blender. A spray assembly is coupled to the blender to introduce a coating material for coating the media received within the blender. The system may further include a media supply with a conveyor to deliver batches of media to the blender's inlet. The forced-air system may have an air-mover and a heat-exchanger to provide heated air, as well as an exhaust conduit to expel air from the blender. The exhaust conduit can be connected to the air-mover to recirculate the air. Coated media may be transported from the blender to a packaging unit. Some embodiments include a second tapered vertical blender and spray assembly, allowing for simultaneous coating processes.

### BACKGROUND

Certain types of media are coated to achieve improved performance. For example, it has been found that certain types of fertilizer have an enhanced effectiveness when a coating is applied. Previous blending systems have used drip bars to introduce a coating material into a blender containing the media to be coated. In these systems, the media is blended until the coating has set. These previous systems would provide non-uniform coating (e.g., partial coverage) of the media.

### SUMMARY

At a high level, aspects disclosed herein may include a tapered vertical blender and a media coating system having a tapered vertical blender, configured to provide an improved coating (e.g., full coverage) to a batch of media. Lower viscosity coating materials may be used better envelop the media to be coated. The tapered vertical blender includes a container for receiving the media and a screw auger for blending the media within the container. A spray assembly is coupled to the tapered vertical blender and is configured for communicating a coating material to the media received within the container. The media coating system further includes a forced-air system to provide air movement within the container to assist with setting the coating material on the media in the container. The forced-air system may include a pre-heating element in order to move air heated above ambient temperature into the container to further assist with setting the coating material on the media.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view of a tapered vertical blender according to an embodiment of the present disclosure;

FIG. 2 is a side view of the tapered vertical blender of FIG. 1 according to an embodiment of the present disclosure;

FIG. 3 is a front view of the tapered vertical blender of FIG. 1 according to an embodiment of the present disclosure;

FIG. 4 is a bottom view of the tapered vertical blender of FIG. 1 according to an embodiment of the present disclosure;

FIG. 5 is a top view of the tapered vertical blender of FIG. 1 according to an embodiment of the present disclosure;

FIG. 6 is a side view of a cross-section of the tapered vertical blender taken along cut-line 6-6 in FIG. 5 according to an embodiment of the present disclosure; and

FIG. 7 is a schematic view of media coating system according to an embodiment of the present disclosure.

### DETAILED DESCRIPTION

Hereinafter, preferable embodiments of a media coating system using a tapered vertical blender will be described with reference to accompanying drawings.

Also, the below-mentioned terms are defined in consideration of the functions in the present disclosure and may be changed according to the intention of users or operators or custom. The following embodiments do not limit the scope of the present disclosure and are merely exemplary of the components presented in the claims of the present disclosure.

Parts irrelevant to the description will be omitted for a clear description of the present disclosure. The same or similar reference numerals will be assigned to the same or similar components throughout this specification. Throughout this specification, when it is mentioned that a portion “includes” an element, it means that the portion does not exclude but further includes other elements unless there is a special opposite mention.

At a high level, aspects disclosed herein may include a tapered vertical blender and a media coating system having a tapered vertical blender, configured to provide an improved coating to a batch of media. Lower viscosity coating materials may be used better envelop the media to be coated. The tapered vertical blender includes a container for receiving the media and a screw auger for blending the media within the container. A spray assembly is coupled to the tapered vertical blender and is configured for communicating a coating material to the media received within the container. The media coating system further includes a forced-air system to provide air movement within the container to assist with setting the coating material on the media in the container. The forced-air system may include a pre-heating element in order to move air heated above ambient temperature into the container to further assist with setting the coating material on the media.

As used herein, “media” refers to materials such as flakes, granules, particles, powders, or pellets. For example, in the context of fertilizer, media may comprise granules of a fertilizing agent (e.g., black urea).

As used herein, “coating material” refers to a substance applied to the surface of media. For example, in the context of fertilizer, a coating material refers to a substance applied to the surface of a fertilizer particle to control solubility, nutrient release rate, and other characteristics. The coating material may comprise humic acid, sulfur, wax, and/or polymers. Polymer coatings may comprise organic polymers (e.g., palm stearin, pine oleoresin, etc.), resin-based polymers (e.g., polyurethane, ethylene-vinyl acetate, polyolefin, styrenic block copolymers, etc.), or polyethylene polymers.

In general, the media coating system described herein utilizes small droplets of the coating material sprayed over a large area of the media received in a tapered vertical blender in order to provide a more complete coating of the media. In aspects, a lower viscosity coating materials may be used to allow the coating material to more fully envelop the media to be coated. Utilizing lower viscosity coating materials as compared to prior coating systems is possible because of a forced-air system that aids in setting the coating on the media. For example, in some aspects the coating material may have a viscosity in the range of X to Y.

The coating process may occur in a tapered vertical blender. The process may begin with a batch of media being delivered to the tapered vertical blender. An auger assembly may move the media within the tapered vertical blender while a spray assembly may deliver the coating material. A forced-air system may move air through the tapered vertical blender while the coating material is being applied and/or is setting on the media. After the media is coated, it may be removed and communicated to a packaging unit or other holding container.

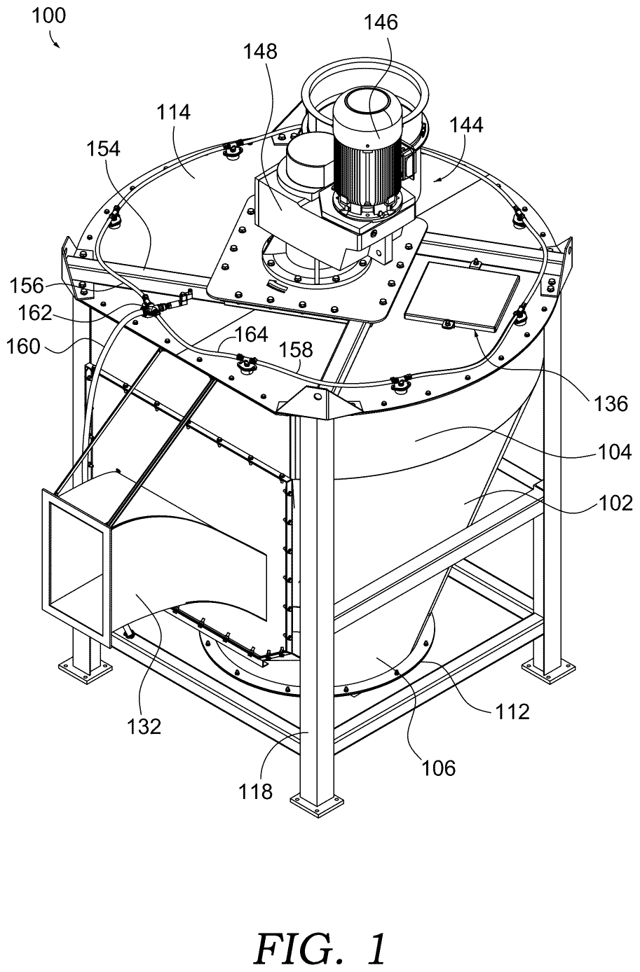

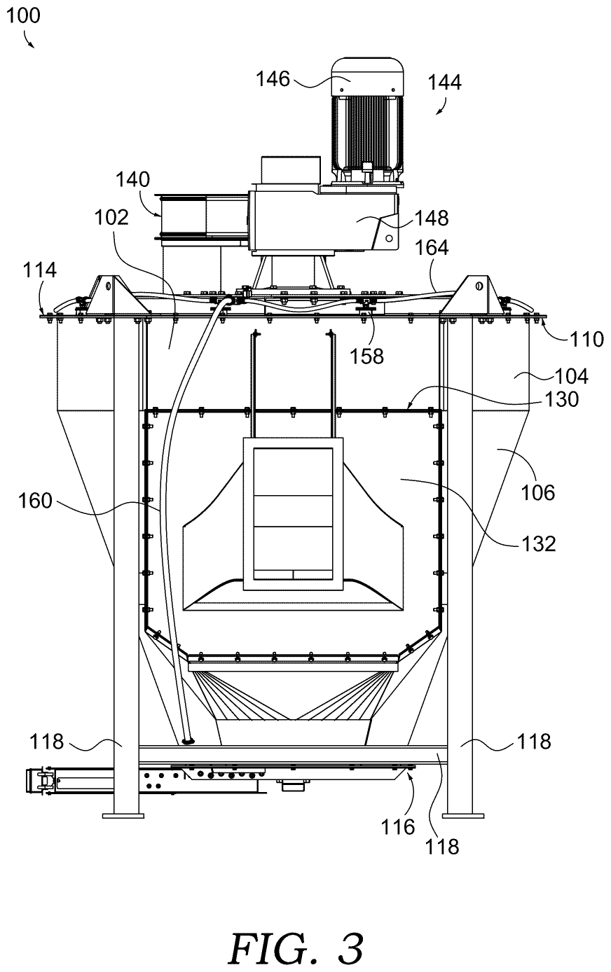

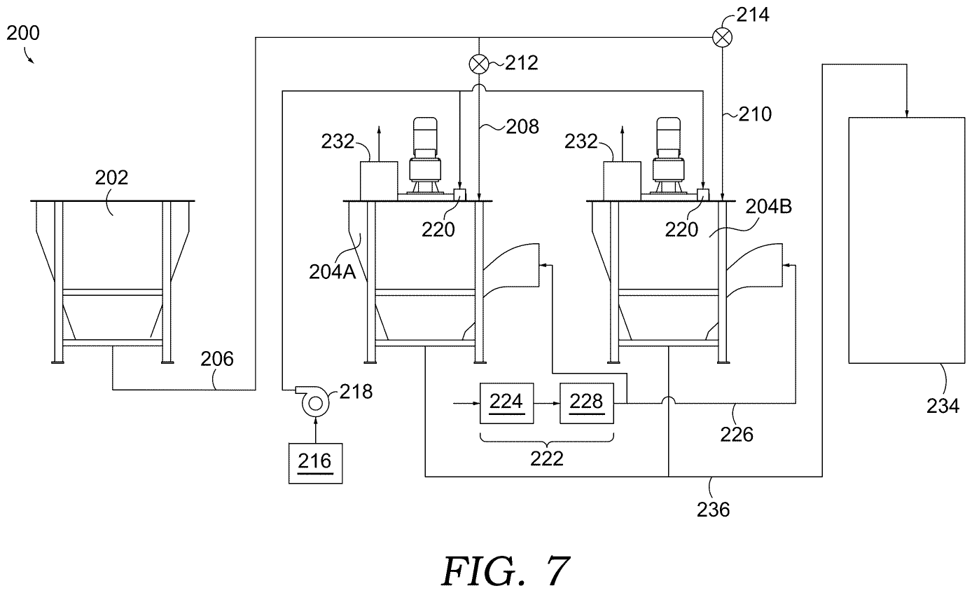

Referring initially to FIGS. 1-6, a tapered vertical blender 100 will be described. The tapered vertical blender 100 is configured for use in a media coating system (e.g., media coating system 200 described below in reference to FIG. 7).

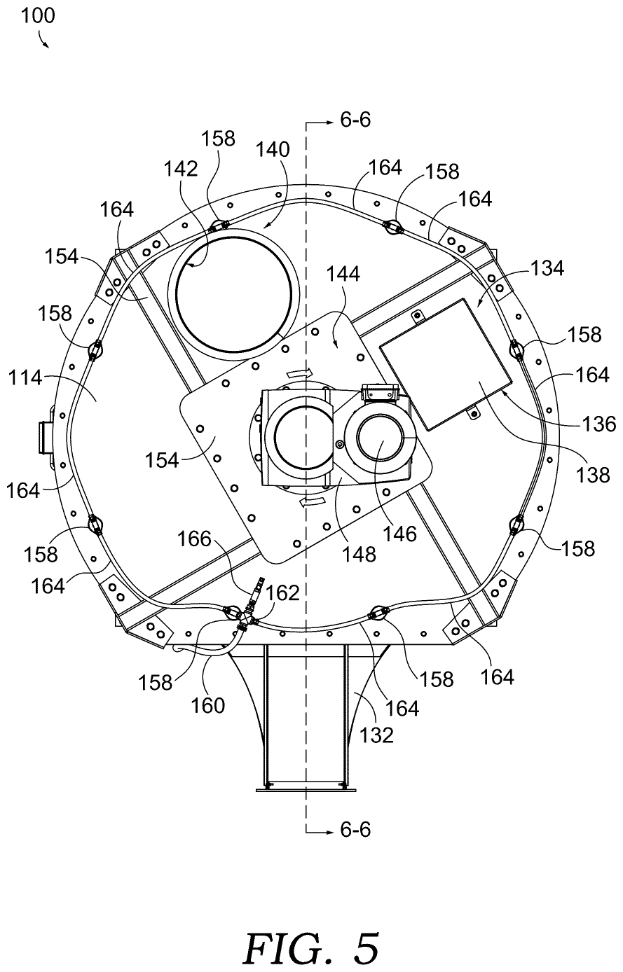

The tapered vertical blender 100 includes a container 102 having a top portion 104 and a tapered portion 106. In some aspects, the container 102 only includes a tapered portion 106. As depicted in FIGS. 1-5, the top portion 104 may be generally cylindrical and have a constant diameter. In the illustrated aspect, the top portion 104 has one side that is not curved but instead presents a planar surface that is defined by a chord line when viewed from above (seen in FIG. 5). The planar surface may ease joining of a transition duct (described below) to the container 102.

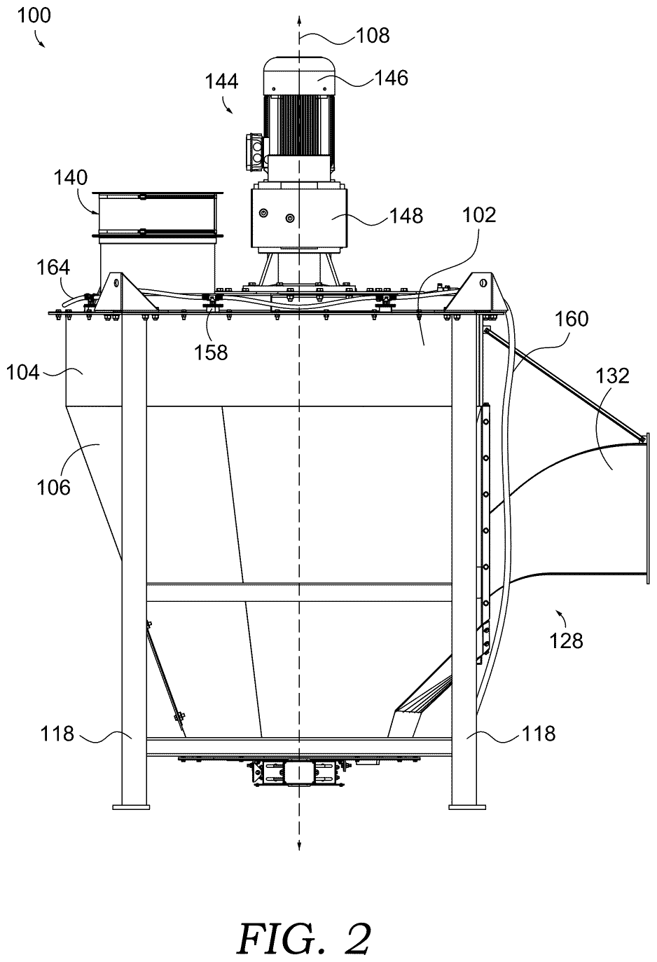

The tapered portion 106 may have a tapered profile along a vertical central axis 108 (best seen in FIG. 2) such that a diameter of the tapered portion 106 decreases downwardly along the vertical central axis 108. In some aspects, the tapered portion 106 has a frustoconical shape. In other aspects, the tapered portion 106 has an irregular shape configured to couple with the transition duct (described below). The tapered portion 106 may extend downwardly from a bottom of the top portion 104.

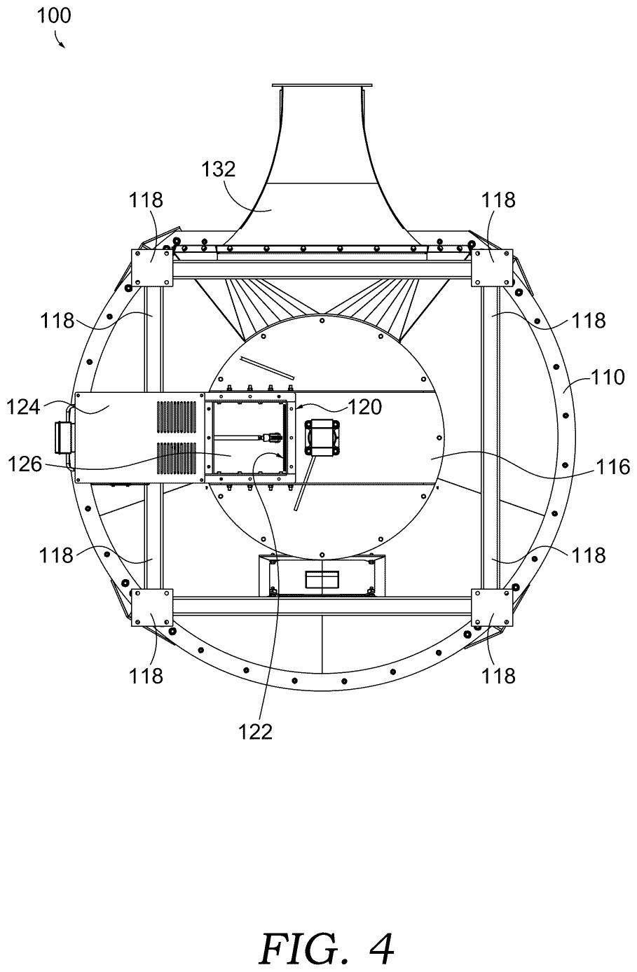

The container 102 may have a top opening defined by a perimeter of a top end of the top portion 104 and a bottom opening defined by a perimeter of a bottom end of the tapered portion 106. Along the perimeter of the top portion 104, a first flange 110 (best seen in FIG. 4) may extend radially outwardly. Similarly, along the perimeter of the tapered portion 106, a second flange 112 (best seen in FIG. 1) may extend radially outwardly. The first flange 110 may be adapted to couple with a lid 114. For example, the lid 114 may be sheet metal bolted to the container 102 such that the lid 114 is removably coupled thereto. Removably coupling the lid 114 to the container 102 may provide improved access to an interior of the container 102 for cleaning, maintenance, and the like. In another example, the lid 114 may be welded, bonded, fastened, or otherwise affixed to the container 102 such that the lid 114 is not removably coupled.

Likewise, the second flange 112 may be adapted to couple with a bottom plate 116 (best seen in FIG. 4). Similar to the lid 114, the bottom plate 116 may be removably or irremovably coupled to the container 102. While each is described herein as a single panel, both the lid 114 and the bottom plate 116 may comprise a plurality of panels joined together (e.g., welded) to form a unitary panel.

The container 102 may be mounted to a frame 118. For example, the frame 118 may include one or more vertical posts extending downwardly from the first flange 110. The frame 118 may also include one or more cross beams. The frame 118 may be set upon a floor or working surface. In other aspects, the frame 118 may be set upon piers (not shown) that elevate the container 102 above the floor or working surface to provide clearance for media to be removed from a bottom of the container 102.

For example, the bottom plate 116 includes a media outlet 120. The media outlet 120 may include a first opening 122 and a valve 124 coupled to the first opening 122. The valve 124 is configured to restrict communication through the first opening 122. The valve 124 comprises a gate 126 that can be moved between an extended position (as seen in FIG. 4) and a withdrawn position (not shown). In other aspects, the valve 124 may comprise other types of valves (e.g., an iris valve, a slide valve, a butterfly valve, etc.).

As discuss below, a conveyance mechanism may be coupled to the media outlet 120. Thus, after the media has been coated, the valve 124 may open to permit the coated media to be communicated away from the tapered vertical blender 100.

The container 102 also includes an air intake 128. The air intake 128 may include a second opening 130 to which a transition duct 132 is coupled. The transition duct 132 may be adapted for joining an air supply duct (not shown), which communicates air from an air mover, with the container 102. The second opening 130 may be positioned in a lower part of the tapered portion 106. It is preferred to position the second opening 130 on an opposite end and side from an air exhaust (e.g., air exhaust 140 described below) to ensure the air travels through the media during the coating process.

Turning to FIG. 5, a top of the container 102 is depicted to include a media inlet 134. The media inlet 134 is schematically represented by a third opening 136 and a cover plate 138. In other aspects, a valve may be coupled to the third opening 136 and configured to restrict communication of media into the container 102. For example, a conduit may be coupled to the third opening 136 and a valve may control communication of media through the conduit. During a coating process, media may be communicated into the container 102 through the media inlet 134. In aspects, the coating process may operate in batches such that a batch load is communicated through the media inlet 134 for each cycle.

The top of the container 102 also includes an air exhaust 140. The air exhaust 140 may include a fourth opening 142. The fourth opening 142 may discharge air from the container 102 to a conduit (not shown) that communicates the exhaust air away from the tapered vertical blender 100. In some aspects, the air exhaust 140 includes a screen (not shown) or other type of filter that permits air to pass but restricts media from exiting the container 102.

In the illustrated aspect, the third opening 136 and the fourth opening 142 are depicted as formed in the lid 114. In other aspects, one or more of the third opening 136 and the fourth opening 142 may be formed in another part of the container 102. For example, one or more of the third opening 136 and the fourth opening 142 may be formed in the top portion 104 on a side of the container 102. In another example, instead of having the removable lid 114 the container 102 may have a top panel through which one or more of the third opening 136 and the fourth opening 142 may be formed.

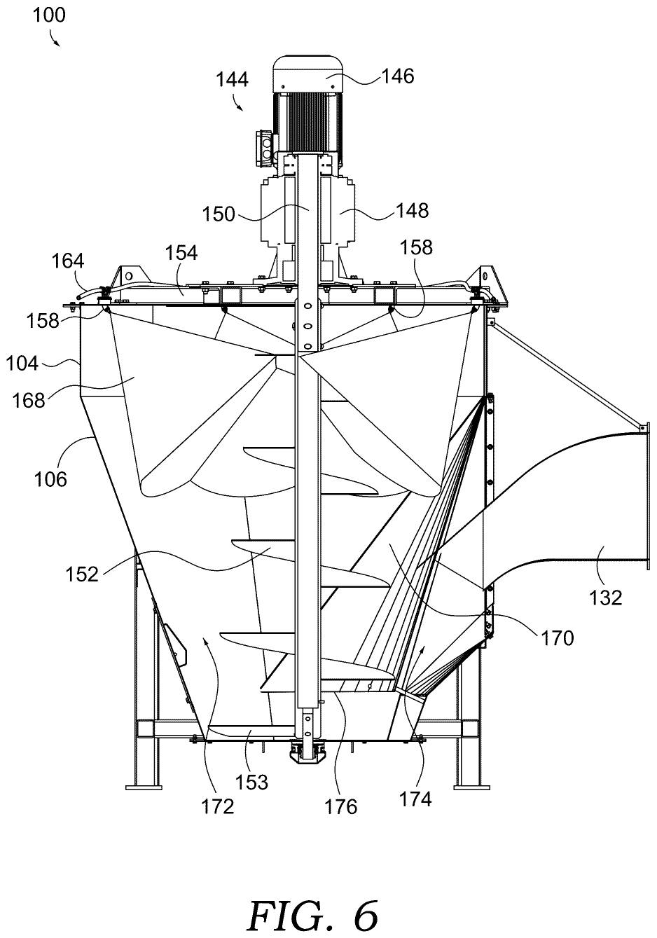

The top of the container 102 may also include an auger assembly 144. The auger assembly 144 may include a motor 146, a gear box 148, an auger screw 150 having auger blades 152 (best seen in FIG. 6), and an auger mounting frame 154. The auger mounting frame 154 may be coupled to the top of the container 102. For example, the auger mounting frame 154 may be coupled to one or more of the lid 114 and the frame 118.

The auger screw 150 may be positioned to extend into the container 102 along the vertical central axis 108. The motor 146 may be offset from the auger screw 150 and coupled via a gear box 148 that transmits rotational energy from the motor 146 to the auger screw 150. The auger blades 152 may extend radially away from the auger screw 150. In some aspects, a sweep arm 153 (best seen in FIG. 6) may be coupled to a bottom end of the screw auger 150 to assist with discharge of coated media from the container 102. In operation, the auger blades 152 lifts the media located in a central region of the container 102 thereby causing the media located in a peripheral region of the container to drop. Thus, a media flow is developed when the auger assembly 144 is operated, which enables more uniform coverage of the media during the coating process.

The top of the container 102 also includes a spray assembly 156. The spray assembly 156 includes a plurality of nozzles 158 that are configured to spray a coating material onto media received in the container 102. The nozzles 158 may be distributed around the vertical central axis 108 in an array. The nozzles 158 may extend through the top of the container 102 (e.g., the lid 114).

The spray assembly 156 also includes an intake line 160 that is in communication with a coating material supply (not shown). The intake line 160 may terminate at a control valve 162. From the control valve 162, the coating material may be communicated to the plurality of nozzles 158 in series as depicted. Thus, each nozzle 158 may be in communication with an adjacent nozzle 158 via a distribution line 164. In another aspect, the coating material may be communicated in parallel to the plurality of nozzles 158. A nozzle blow-off port 166 may be coupled to a downstream side of the valve 162 to allow a blow-off after the spraying process is complete. In other words, air may be used to clear the distribution lines 164 and the plurality of nozzles 158 to avoid clogging or other interference.

Referring to FIG. 6, a cross-section of the tapered vertical blender 100 taken along cut line 6-6 in FIG. 5 is illustrated. In the illustrated aspect, the plurality of nozzles 158 are spraying the coating material, which is depicted as cones of coating material 168 emanating from each of the nozzles 158 shown. While shown as cones of coating material 168 for illustrative purposes in FIG. 6, the sprayed coating material is actually emitted as fine droplets during coating process which helps provide greater coverage around each of the media granules.

A shroud 170 is provided between the second opening 130 of the air intake 128 and the screw auger 150 and the auger blades 152. The shroud 170 serves to separate a blending chamber 172 from the air intake plenum 174. The illustrated shroud 170 is attached along all but a bottom edge 176 to the container 102, thus proving a physical barrier between the blending chamber 172 and the air intake plenum 174. The bottom edge 176 is positioned near the bottom of the tapered portion 106. In the illustrated aspect, the bottom edge 179 is positioned below the lowest auger blade 152, which results in the media granules not being lifted into the air intake plenum 174.

During the coating process described herein, forced-air is communicated into the container through the air intake 128. The air then travels through the blending chamber 172 and passes by the media granules to help improve the setting of the coating material on the media granules. The air is then discharged from the container 102 through the air exhaust 140.

Turning to FIG. 7, a media coating system 200 is depicted. The media coating system 200 may include a hopper 202 for storing media before it is coated. In some aspects, the hopper 202 may pre-condition the media so that the coating material is more easily set when applied. In further aspects, the hopper 202 may pre-condition the media to enhance other characteristics of the media prior to coating.

After any pre-conditioning is completed, a batch of the media is communicated from the hopper 202 to a tapered vertical blender 204 where the coating material is applied to the media. In some aspects, the media is communicated from the hopper 202 to the tapered vertical blender 204 via a conveyor 206 (e.g., a screw conveyor). The tapered vertical blender 204 may comprise the tapered vertical blender 100 described above.

As illustrated in FIG. 7, the media coating system may include a plurality of tapered vertical blenders 204. Thus, the conveyor 206 may be configured to communicate a first batch of media to a first tapered vertical blender 204A and a second batch of media to a second tapered vertical blender 204B. For example, the conveyor 206 may deliver a batch of media to a conduit having a first portion 208 in communication with the first tapered vertical blender 204A and a second portion 210 in communication with the second tapered vertical blender 204B. A first valve 212 may control communication through the first portion 208 and a second valve 214 may control communication through the second portion 210.

The media coating system 200 may include a coating material supply 216 and a pump 218 configured to communicate the coating material to the first tapered vertical blender 204A and/or the second tapered vertical blender 204B. For example, the pump 218 may supply the coating material to a spray assembly 220 (e.g., spray assembly 156) of one of the tapered vertical blenders 204A,204B. The media in the tapered vertical blender 204A or 204B is then coated with the coating material. After the media has been coated, the spray assembly 220 of the tapered vertical blender 204A or 204B can be cleared (e.g., blown out) with pressurized air to clear the nozzles and lines, which reduces clogging.

In order to coat the media with a viscous coating material, enhanced setting of the coating material is achieved using a forced-air system 222. The forced-air system 222 may include an air-mover 224. The air-mover 224 may comprise a fan, a blower, a compressor, and the like. For example, the air-mover 224 may comprise a centrifugal fan. In one aspect, the air-mover 224 may communicate ambient air to an air-intake 230 of one or more of the tapered vertical blenders 204A, 204B. For example, a duct 226 may communicate the air from the air-mover 224 to the air-intake 230.

In further aspects, the setting of the coating material may be further enhanced by heating the air communicated to the air-intake 230. Thus, in aspects, the duct 226 may communicate the air through a heat-exchanger 228 prior to delivering the air to the air-intake 230. For example, the air may pass a heating coil that raises the temperature of the air above the ambient temperature.

Thus, air is forced through the media contained in the tapered vertical blenders 204A,204B during the coating process to enhance the setting of the coating material on the media granules. After which, the air is discharged through an air exhaust 232. The discharged air may be vented to the atmosphere, in some aspects. Alternatively, the discharged air may be recycled and communicated to an inlet of the air-mover 224. When the air is recycled, less energy may be needed to reheat the recycled air.

After the coating material is applied to media, the coated media is communicated from the first tapered vertical blender 204A and/or the second tapered vertical blender 204B to a packaging unit 234 that packages the coated media. In aspects, a transport conveyor 236 communicates the coated media from the plurality of tapered vertical blenders 204 to the packing unit 234.

[Europe or China filing anticipated? Add clauses here.]

The present invention is not limited to the described specific embodiments and descriptions described above. Various modifications can be made by anyone skilled in the art without departing from the subject matter of the present invention as defined by the appended claims. Such modifications fall within the scope of protection of the present invention.

What is claimed is:

1. A tapered vertical blender configured for media coating and drying via a forced-air system, the tapered vertical blender comprising:
a container having a media inlet, a media outlet, an air intake, and an air exhaust, each in communication with an interior of the container;
an auger assembly comprising a screw auger coupled to a motor, the auger assembly coupled to the container such that the screw auger extends into the interior of the container and is configured to move media received in the container; and
a spray assembly coupled to the container and configured for spraying a coating material on media received in the container.

2. The tapered vertical blender of claim 1, wherein the container has a cylindrical top portion and a tapered portion extending downwardly from the cylindrical top portion, the diameter of the tapered portion decreasing along a vertical axis from cylindrical top portion to a bottom of the container.

3. The tapered vertical blender of claim 2, wherein the media outlet comprises a first opening formed in a bottom of the container, the first opening configured for communicating media out of the container.

4. The tapered vertical blender of claim 3 further comprising a valve coupled to the first opening.

5. The tapered vertical blender of claim 2, wherein the air intake comprises a second opening formed in the tapered portion of the container.

6. The tapered vertical blender of claim 5 further comprising a transition duct coupled to the container at the second opening.

7. The tapered vertical blender of claim 5 further comprising a shroud coupled to an interior of the container between the screw auger and the second opening, the shroud restricting airflow into the container such that air entering the container must flow under the shroud before moving into a main chamber of the interior of the container.

8. The tapered vertical blender of claim 1, wherein the screw auger extends downwardly through a top of the container.

9. The tapered vertical blender of claim 1, wherein the media inlet comprises a third opening formed in a top of the container and the air exhaust comprises a fourth opening formed in the top of the container.

10. The tapered vertical blender of claim 1, wherein a top of the container comprises a lid coupled to the container.

11. The tapered vertical blender of claim 1, wherein the spray assembly comprises an array of spray nozzles coupled to a top of the container and radially spaced around the screw auger.

12. A media coating system:
a tapered vertical blender;
a forced-air system in communication with the tapered vertical blender, the forced-air system configured to communicate air through the tapered vertical blender;
a spray assembly coupled to the tapered vertical blender and configured to communicate a coating material into the tapered vertical blender for coating media received in the tapered vertical blender.

13. The media coating system of claim 12 further comprising a media supply configured to communicate media into the tapered vertical blender, the media supply comprising a conveyor that delivers a batch of media to a media inlet of the tapered vertical blender.

14. The media coating system of claim 12, wherein the forced-air system comprises an air mover and a heat exchanger upstream from the tapered vertical blender, the forced-air system configured to communicate heated air into an air intake opening of the tapered vertical blender.

15. The media coating system of claim 13, wherein the forced-air system comprises an exhaust conduit coupled to an air exhaust opening of the tapered vertical blender, the exhaust conduit configured to communicate air out of the tapered vertical blender.

16. The media coating system of claim 15, wherein the exhaust conduit is in communication with the air mover and returns the air received from the tapered vertical blender to the air mover.

17. The media coating system of claim 12 further comprising a treated media conveyance system configured to communicate treated media from the tapered vertical blender to a packaging unit.

18. The media coating system of claim 12 further comprising:
a second tapered vertical blender,
the forced-air system in communication with the second tapered vertical blender, the forced-air system configured to communicate air through the tapered vertical blender; and
a second spray assembly coupled to the second tapered vertical blender and configured to communicate the coating material into the second tapered vertical blender for coating media received in the tapered vertical blender.

19. The media coating system of claim 12, wherein the media received in the tapered vertical blender comprises black urea.

20. The media coating system of claim 12, wherein the coating material comprises humic acid.
